(19) United States
(12) Patent Application Publication
(10) Pub. No.: US 2025/0383972 A1
(43) Pub. Date: Dec. 18, 2025

(54) SYSTEM AND METHOD FOR IMPROVING STORAGE DEVICE UTILIZATION

(71) Applicant: Samsung Electronics Co., Ltd., Gyeonggi-do (KR)

(72) Inventor: Marc Timothy JONES, Longmont, CO (US)

(21) Appl. No.: 19/213,472

(22) Filed: May 20, 2025

Related U.S. Application Data
(60) Provisional application No. 63/659,593, filed on Jun. 13, 2024.

(51) Int. Cl. G06F 11/34

(52) U.S. Cl. CPC G06F 11/3433; G06F 11/3452; G06F 11/3485

(57) ABSTRACT

A storage device and method thereof are provided. The method includes monitoring a workload for a host's utilization of a memory device included in the storage device, analyzing the monitored workload by detecting patterns of use of the memory device, generating a recommendation to improve the host utilization, based on the analyzed, monitored workload, and writing the recommendation to a log page in the storage device.

### CROSS-REFERENCE TO RELATED APPLICATION

This application claims the priority benefit under 35 U.S.C. § 119 (e) of U.S. Provisional Application No. 63/659,593, which was filed on Jun. 13, 2024, the disclosure of which is incorporated by reference in its entirety as if fully set forth herein.

### BACKGROUND

A nonvolatile memory express (NVMe) solid-state drive (SSD) is a complex storage system with an intricate interface and a plethora of configuration knobs.

Some methods of use are more performant than others (e.g., data alignment, optimal sizes for writes, etc.).

However, drives currently provide no hints to a host about how to improve utilization (e.g., a black box). Although drive vendors may advertise their “hints” (e.g., in either documentation, or through an NVMe Identify command response), these are generally passive recommendations, and a customer may not fully comprehend them nor use them.

Accordingly, a need exists for a method to ensure that a customer fully understands where performance or other metrics are not fully utilized based upon their specific input/output (I/O) model.

### SUMMARY

An aspect of this disclosure is to capture host utilization of a drive in order to make recommendations to the host to improve performance, endurance, power-consumption, etc.

Another aspect of this disclosure is to gather conditions like completion queue (CQ) full, which limits the drive taking on new commands.

Accordingly, this disclosure may benefit enterprise customers whose utilization can differ from standard Windows/Linux driver behaviors.

This disclosure may also benefit standard Linux drivers through the use of quirks (i.e., drive-specific behaviors in the kernel).

In accordance with an aspect of the disclosure, a method performed by a storage device is provided. The method includes monitoring a workload for a host's utilization of a memory device included in the storage device; analyzing the monitored workload by detecting patterns of use of the memory device; generating a recommendation to improve the host utilization, based on the analyzed, monitored workload, and writing the recommendation to a log page in the storage device.

In accordance with another aspect of the disclosure, a storage device is provided, which includes a memory device; a monitoring unit configured to monitor a workload for a host's utilization of the memory device; an analysis unit configured to analyze the monitored workload by detecting patterns of use of the memory device; and a recommendation unit configured to generate a recommendation to improve the host utilization, based on the analyzed, monitored workload, and write the recommendation to a log page in the storage device.

In accordance with another aspect of the disclosure, an NVMe SSD is provided. The NVMe SSD includes a memory device; and a controller configured to monitor a workload for a host's utilization of the memory device, analyze the monitored workload by detecting patterns of use of the memory device, generate a recommendation to improve the host utilization, based on the analyzed, monitored workload, and write the recommendation to a log page in the NVMe SSD.

### BRIEF DESCRIPTION OF THE DRAWING

In the following section, the aspects of the subject matter disclosed herein will be described with reference to exemplary embodiments illustrated in the figures, in which:

FIG. 1 illustrates a storage system, according to an embodiment;

FIG. 2 illustrates an NVMe control unit in a storage system, according to an embodiment; and

FIG. 3 is a flowchart illustrating a method performed by a storage device, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments.

Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” or “unit” refers to any combination of software, firmware and/or hardware configured to provide the functionality described herein in connection with a module or unit. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules or units may, collectively or individually, be embodied as circuitry that forms part of a larger system, for example, but not limited to, an integrated circuit (IC), system on-a-chip (SoC), an assembly, and so forth.

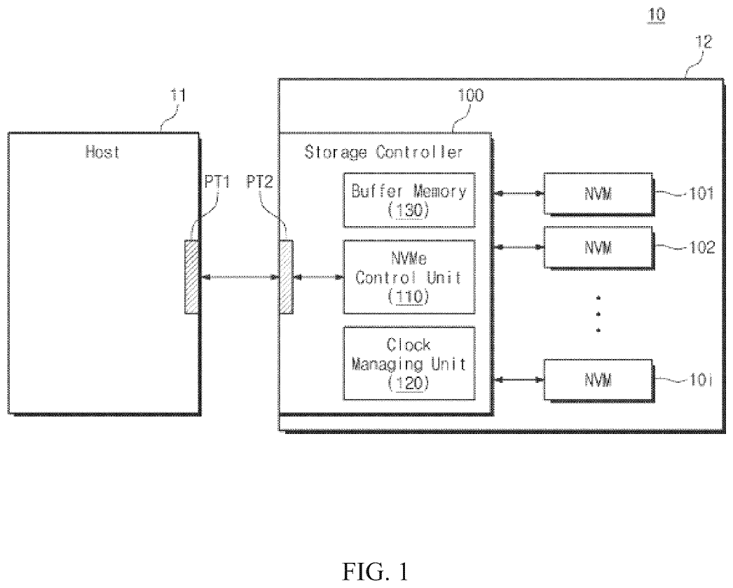

FIG. 1 illustrates a storage system, according to an embodiment.

Referring to FIG. 1, the storage system 10 includes a host 11 and a storage device 12, e.g., an NVMe SSD. The storage device 12 may be defined by a single, comprehensive, integral housing that includes therein tangible elements as illustrated in FIG. 1.

The host 11 may store data in the storage device 12 or may read data stored in the storage device 12. The host 11 may communicate with the storage device 12 through a first port PT1. In an embodiment, the first port PT1 may be a physical port that is based on a peripheral component interconnect express (PCIe) protocol. However, the present disclosure is not limited thereto.

Below, to describe technical feature(s) of the present disclosure briefly, it is assumed that the host 11 and the storage device 12 communicate with each other through a PCIe protocol-based physical port such as the first port PT1 and second port PT2. Also, it is assumed that the storage device 12 is an NVMe device that operates based on an NVMe interface. However, this assumption is provided as an illustrative example and the disclosure is applicable to other technologies as well.

The host 11 includes a memory, which may include a submission queue (SQ) and a CQ. The SQ may be storage such as dedicated storage that stores a command to be provided to the storage device 12. The CQ may be storage such as dedicated storage that stores completion information about an operation completed in the storage device 12 based on the command.

The storage device 12 includes a storage controller 100 and multiple nonvolatile memory devices 101 to 10i. The storage controller 100 may be an NVMe device operating based on the NVMe interface, as described above. That is, the storage controller 100 may be configured to communicate with the host 11 in a predefined manner that is based on the NVMe interface.

In the descriptions herein, reference is made to a variety of controllers (e.g., a storage controller 100), units (e.g., an NVMe control unit 110), and blocks (e.g., an intellectual property block). Any of these controllers, units, and/or blocks may be embodied by a processor that executes a particular dedicated set of software instructions, such as a software module. The processor executes the instructions to control operations of the controller(s), unit(s) and/or blocks. Multiple of the controllers, units and blocks may be defined by a single common processor and different dedicated sets of software instructions. Any processor of a controller, unit or block described herein is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor is configured to execute software instructions in order to perform functions as described in the various embodiments herein. A processor may be a general-purpose processor or may be part of an application specific integrated circuit (ASIC). A processor may also be a microprocessor, a microcomputer, a processor chip, a controller, a microcontroller, a digital signal processor (DSP), a state machine, or a programmable logic device. A processor may also be a logical circuit, including a programmable gate array (PGA) such as a field programmable gate array (FPGA), or another type of circuit that includes discrete gate and/or transistor logic. A processor may be a central processing unit (CPU), a graphics processing unit (GPU), or both. Additionally, any processor described herein may include multiple processors, parallel processors, or both. Multiple processors may be included in, or coupled to, a single device or multiple devices. Sets of instructions can be read from a computer-readable medium. Further, the instructions, when executed by a processor, can be used to perform one or more of the methods and processes as described herein. In a particular embodiment, the instructions may reside completely, or at least partially, within a main memory, a static memory, and/or within a processor during execution.

Dedicated hardware implementations, such as ASICs, programmable logic arrays and other hardware components, can be constructed to implement one or more of the controller(s), unit(s) and/or block(s) described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

The storage controller 100 may be implemented with a circuit, with a processor that executes software instructions, or a combination of a circuit and a processor that executes instructions. The nonvolatile memory devices 101 to 10i may operate under control of the storage controller 100. Each of the nonvolatile memory devices 101 to 10i may be a NAND flash memory device, but are not limited thereto.

The storage controller 100 includes an NVMe control unit 110, a clock managing unit 120, and a buffer memory 130. The NVMe control unit 110 may be configured to analyze or interpret various signals provided from the host 11 through the second port PT2 and to perform an operation corresponding to the analyzed or interpreted result. In an embodiment, the NVMe control unit 110 may include various function blocks for performing the above-described operations. As described previously, any of a controller, a unit, and a block (which includes a function block and an intellectual property block) may be implemented with a circuit, with a processor that executes instructions, or a combination of a circuit and a processor that executes instructions. A function block or multiple function blocks of the NVMe control unit 110 may include a memory that stores instructions and a processor that executes the instructions.

In accordance with an embodiment, the NVMe control unit 110 may capture host utilization of the storage device 12 in order to make recommendations to the host 11, in order to improve performance, endurance, power-consumption, etc.

The clock managing unit 120 may be configured to manage various clocks that are used in the storage controller 100. For example, a clock may be used with a completion block. That is, the clock may be used to identify how long a command has been completed, but not able to have a completion queue entry submitted back to a host for it (e.g., the completion queue is full).

The clock managing unit 120 may provide multiple clocks to the NVMe control unit 110. The multiple clocks may be provided to the multiple function blocks included in the NVMe control unit 110, respectively. Examples of the function blocks may include a queue arbitration block (e.g., which PCIe function/NVMe queue to accept commands (e.g., submission queue elements (SQEs)) from), a completion block (taking command completions and turning them into NVMe completions (e.g., completion queue entries (CQEs)), a command parser block (e.g., that parses commands to route them appropriately (I/O vs. admin, etc.), a host memory manager block (e.g., manages a physical region page (PRP) and scatter gather list (SGL) ingest/direct memory access (DMA) to/from the host), etc.

The clock managing unit 120 may control or manage a clock to be provided to each function block, depending on an operation state of each of the multiple function blocks included in the NVMe control unit 110. Control may include affirmatively providing or not providing a clock, based on determining or recognizing an operation state of a function block.

For example, the NVMe control unit 110 may include a command fetch block configured to fetch a command from the SQ of the host 11. The clock managing unit 120 may provide a clock to the command fetch block while the command fetch block fetches the command from the SQ. After the command fetch block completes a command fetch operation, the clock managing unit 120 may block or deactivate the clock being provided to the command fetch block.

In FIG. 1, the clock managing unit 120 is illustrated as being separate from the NVMe control unit 110. However, clock managing unit 120 is not limited thereto. For example, the clock managing unit 120 may be included in the NVMe control unit 110.

The buffer memory 130 may be configured to store write data provided from the host 11 or read data provided from the multiple nonvolatile memory devices 101 to 10i. Alternatively, the buffer memory 130 may be placed outside the storage controller 100.

As described above, the storage controller 100 may provide a clock to a function block which is performing a relevant operation, depending on operation states of internal function blocks. In other words, the storage controller 100 does not provide a clock to function blocks that do not perform an operation (i.e., while they are not performing an operation). For example, the storage controller 100 may start and stop a clock signal accordingly, based on being enabled/disabled by the host 11. Accordingly, since a clock is prevented from being provided unnecessarily or since the whole time to provide a clock decreases, power consumption of the storage device 12 is reduced.

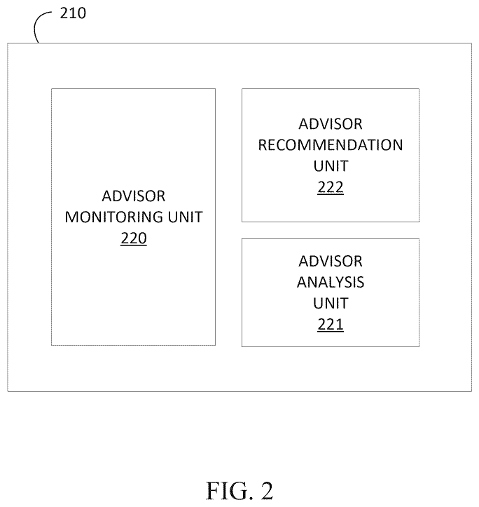

FIG. 2 illustrates an NVMe control unit in a storage system, according to an embodiment. For example, the NVMe control unit 110 of FIG. 1 may be configured as illustrated in FIG. 2.

Referring to FIG. 2, the NVMe control unit 210 includes an advisor monitoring unit 220, an advisor analysis unit 221, and an advisor recommendation unit 222. Herein, the operations of the advisor monitoring unit 220, the advisor analysis unit 221, and the advisor recommendation unit 222 may be collectively referred to as “the advisor function”.

The advisor monitoring unit 220, while a host workload runs, monitors I/O, queues, command parameters, queue depths (QDs), etc. For example, for the queues, the advisor monitoring unit 220 may monitor their utilization, concurrency (e.g., writing multiple commands at once, which minimizes doorbell writes to the device), submission QD used (e.g., is the queue too small, or too large), completion QD used (e.g., is the host draining completions efficiently, allowing it to become full, which holds commands hostage in the controller), etc. The advisor monitoring unit 220 may be provided to perform data monitoring and collection of statistics and events (such as through a get/set feature). Various data-collection and monitoring elements in hardware and firmware may be used to measure the utilization of the drive. For example, monitoring may identify unaligned 512B writes (which require a read-modify-write for 4 KB media units). Counting these unaligned 512B writes and reporting permits a host to understand the performance degradation that may result.

In a host memory block, utilization of SGLs may be monitored for data movement that can limit performance. Examples of this may include fragmentation (i.e., using too many SGL data descriptors to describe host memory). Each SGL may represent a contiguous range of memory, and should be DMAd individually to the controller from the host. Generally, the more data described (contiguously) per SGL descriptor, the more efficient the data transfer.

The advisor analysis unit 221 analyzes the monitored workload and records any patterns therein that would result in decreased utilization. Workloads that may be monitored include those that are misaligned (not just 512B with 4 KB+ media units), as well as reads and writes that do not align to a namespace preferred write granularity, a namespace preferred write alignment, or a namespace optimal write size.

The advisor recommendation unit 222 generates recommendations to improve SSD utilization, and writes the recommendations to a log page for reference by the host. For example, the advisor recommendation unit 222 may provide recommendations to the host about inefficiencies of its workload or an inefficient NVMe SSD drive configuration.

For example, based on the foregoing, an enterprise customer may see that a particular CQ spends time in the full condition and this CQ is also the target of multiple SQs. Accordingly, the enterprise customer may remedy this issue by creating SQ/CQ pairs instead of multiple SQs targeting a single CQ. Consequently, performance improves based upon the recommendation from the advisor recommendation unit 222.

Other examples of recommendation methods may include data transfer size recommendations, an indication of sub-optimal SGL representation for data, an indication of improperly sized queues, CQ full conditions (e.g., which limit new command ingest), PCIe misconfiguration (e.g., low maximum payload size (MPS) or maximum read request size (MRRS)), PCIe link errors (e.g., advanced error reporting (AER) information or retries), read-modify-write (RMW)/overwrite, thermal events (e.g., lowering the power mode), lack of reclaim unit (RU) parallelization for flexible data placement (FDP), workload/power-state mismatch, not using queue interrupt coalescing, not honoring atomic boundaries; block size/protection information (PI) size mismatch (e.g., cyclic redundancy check (CRC) efficiency), temperature/endurance (e.g., is an SSD in a hot environment), or various other methods. These types of recommendations may be detected in hardware and/or in firmware. For example, once an NVMe SSD is enumerated and configured by a host device, PCIe configuration registers may be inspected to understand how the host configured PCIe, and what is natively available by the drive. I/O path items, like respecting atomic boundaries, may be recommended (e.g., setting a flag that can later be reported).

Although FIG. 2 illustrates the NVMe control unit 210 including the advisor monitoring unit 220, the advisor analysis unit 221, and the advisor recommendation unit 222, the disclosure is not limited thereto. For example, the NVMe control unit 210 may include additional units and/or modules.

Further, at least two of the advisor monitoring unit 220, the advisor analysis unit 221, or the advisor recommendation unit 222 may be embodied as a single unit.

Additionally, while FIG. 2 is described above with reference to the NVMe control unit 210 including the advisor monitoring unit 220, the advisor analysis unit 221, and the advisor recommendation unit 222, at least one of the advisor monitoring unit 220, the advisor analysis unit 221, or the advisor recommendation unit 222 may be located outside of the NVMe control unit 210, e.g., as a separate unit of the storage controller 100 or the storage device 12 of FIG. 1.

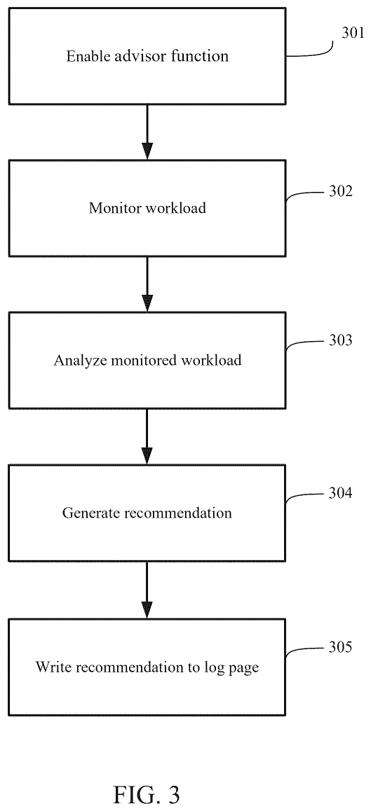

FIG. 3 is a flowchart illustrating a method performed by a storage device, according to embodiment. For example, the method of FIG. 3 may be performed by the storage device 12 of FIG. 1

Referring to FIG. 3, it is assumed that an advisor function of the storage device, e.g., an NVMe SSD is disabled by default.

In step 301, the advisor function of the storage device receives, from a host, an operating command for monitoring during a desired workload.

In step 302, while the workload runs, the advisor function, e.g., the advisor monitoring unit 220 of FIG. 2, monitors the I/O, queues, command parameters, QDs, etc. For example, for queues, the advisor monitoring unit 220 may monitor their utilization, concurrency (e.g., writing multiple commands at once, which minimizes doorbell writes to the device), submission QD used (e.g., is the queue too small, or too large), completion QD used (e.g., is the host draining completions efficiently, allowing it to become full, which holds commands hostage in the controller), etc.

In step 303, the advisor function, e.g., the advisor analysis unit 221 of FIG. 2, analyzes the monitored workload and records any patterns or types of conditions that would result in decreased utilization. The advisor analysis unit 221 may analyze data for each command and check for predefined conditions. For example, patterns or types of conditions that would result in decreased utilization may include unaligned writes, SQ/CQ disparities, thermal Throttling, and PCIe Bottlenecks.

Unaligned Writes: In this example, the storage device, e.g., the NVMe SSD, exposes a namespace formatted to 512B sectors. Since the NVMe SSD implements a larger block size internally (e.g., 4 KB), any writes that are not aligned to 4 KB (e.g., 8 512B sectors written where the starting logical block address (LBA) is modulo 8) results in a read/modify/write. This turns what would be a simple write operation into a read, merge of the write data, and subsequent write to media. This type of operation introduces latency due to the read operation required in order to merge and write. The advisor function can detect these types of operations using the LBA and length. For example, using starting LBA and length, the advisor function can determine when an I/O is aligned to a particular size. For example, given a 512B sector size, an unaligned write may be determined by (starting LBA module 4096)!=0. A similar may able be made for the ending LBA.

Although the example above utilizes 512B sectors as a common sector size and 4 KB as a larger block size, the present disclosure is not limited to these values. For example, larger sector sizes such as 16 KB or 64 KB may also be utilized.

SQ/CQ Disparities: In these examples, queue behaviors are analyzed to understand their utilization and the possible impacts to performance.

In a first example, the SQ can be checked for utilization depth in order to determine if the host keeps the queue (and controller) busy through submission of new work. For example, if the SQ falls to zero depth for a period of time, then that queue is not being fully utilized.

Similarly, in a second example, the CQ can be checked for host consumption CQ entries. If the CQ becomes full and the controller then cannot complete other work, then either the host is not completing work in a timely manner, or the QD may not be sufficient. For example, if the CQ is full for some amount of time, and then becomes empty, then it may be determined that the host is not servicing the CQ in a timely manner. However, if the CQ is full, and then changes to not quite full over and over, then it may be determined that a mixture of the host not servicing properly and the QD being too shallow.

Thermal Throttling: In workloads of high writes, which may lead to thermally significant NVM programs, the NVMe SSD can send an asynchronous event to the host to notify of this condition (since performance will be reduced). An asynchronous event (e.g., an NVMe asynchronous event notification) is a method by which a controller may notify a host of some condition. The NVMe SSD may collect information about thermal events, such as how long the drive spends in warning or critical performance reduction. The advisor function can make this information visible to an administrator along with details of how much performance is impacted. A resolution to thermal throttling is dissipating heat at the drive level, which may include improving airflow or another method for removing heat such as a heat sink. While NVMe SSD may reduce a power state, this may result in degraded performance.

Another analysis that can be done is ensuring that the power mode is sufficient for best performance. If the power state is set to a lower power-state, then the NVMe SSD can report this to the administrator. For example, a power state can be changed to either reduce power consumption or reduce heat generation. If temperature rises in the NVMe device and the power state is not PS0 (highest performance power state), then this is likely something a host should know about.

PCIe Bottlenecks: When a link is trained for the NVMe device, there are two items to validate: 1) link width and 2) link speed. During training, the link width and speed that are set may be suboptimal for the NVMe device. For example, the link may be trained to 2 lanes (instead of the four available) and the link speed could be set at a lower generation (Gen3 instead of Gen4). Unless the administrator inspects the PCIe characteristics at power, they may not be aware of the root-cause of performance degradation.

A host may train a PCIe link with the NVMe device, working through possible link states, speeds, lane widths, etc. While this training may be done in hardware, the NVMe device can view these settings and report them accordingly (e.g., if after training, a Gen4 capable drive is in Gen3, or only 2 lanes are used instead of the available four), then this can be communicated as a warning/recommendation to the host.

In step 304, the advisor function generates a recommendation to improve the host utilization, based on the analyzed, monitored workload.

In step 305, the advisor function, e.g., the advisor recommendation unit 222 of FIG. 2, provides, to the host, recommendations to improve utilization of the storage device. That is, the advisor recommendation unit 222 writes recommendations to an advisor log page.

For example, the host may extract the advisor log page to view the results of recommendations to improve storage device utilization. That is, an enterprise customer disables the advisor function and gathers the log page of recommendations.

More specifically, after the monitoring/collection phase (started by the host), the advisor recommendation unit 222 may populate the advisor log page and notify the host that it can be retrieved and reviewed.

As an alternative, the NVMe control unit 210 could do many of these checks in real-time, and notify the host of an update to the advisor log page through an asynchronous event notification (AEN), providing more of a real-time advisor, than a passive approach.

For example, in view of the foregoing, the enterprise customer may see that a particular CQ spends time in the full condition and this CQ is also the target of multiple SQs. Therefore, the enterprise customer may remedy this issue by creating SQ/CQ pairs instead of multiple SQs targeting a single CQ, thereby improving performance based upon the recommendation.

As described above, a mechanism is provided to monitor and collect data about SSD utilization (e.g., performance, endurance, etc.) within the customer environment. Additionally, a mechanism is provided to use this data to make recommendations to the customer to improve the drive utilization given host workload and configuration.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

Any of the storage devices, storage media, and/or the like, disclosed herein may be implemented with any type of nonvolatile storage media based on solid state media, magnetic media, optical media, and/or the like. For example, in some embodiments, a computational storage device may be implemented as an SSD based on not-AND (NAND) flash memory, persistent memory such as cross-gridded NVM, memory with bulk resistance change, phase change memory (PCM), and/or the like, or any combination thereof.

Any of the storage devices disclosed herein may be implemented in any form factor such as 3.5 inch, 2.5 inch, 1.8 inch, M.2, Enterprise and Data Center Standard Form Factor (EDSFF), NF1, and/or the like, using any connector configuration such as Serial ATA (SATA), Small Computer System Interface (SCSI), Serial Attached SCSI (SAS), U.2, and/or the like.

Any of the storage devices disclosed herein may be implemented entirely or partially with, and/or used in connection with, a server chassis, server rack, dataroom, datacenter, edge datacenter, mobile edge datacenter, and/or any combinations thereof.

Any of the hosts disclosed herein may be implemented with any component or combination of components such as a compute server, a storage server, a network server, a cloud server, and/or the like, a node such as a storage node, a computer such as a workstation, a personal computer, a tablet, a smartphone, and/or the like, or multiples and/or combinations thereof.

Any of the communication connections and/or communication interfaces disclosed herein may be implemented with one or more interconnects, one or more networks, a network of networks (e.g., the internet), and/or the like, or a combination thereof, using any type of interface and/or protocol. Examples may include Peripheral Component Interconnect Express (PCIe), NVMe, NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, Serial ATA (SATA), Small Computer Systems Interface (SCSI), Serial Attached SCSI (SAS), iWARP, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced extensible Interface (AXI), any generation of wireless network including 2G, 3G, 4G, 5G, 6G, and/or the like, any generation of Wi-Fi, Bluetooth, near-field communication (NFC), and/or the like, or any combination thereof.

Any of the functionality described herein, including any of the host functionality, storage device functionally, and/or the like (e.g., any of the storage device controllers, logic, and/or the like) may be implemented with hardware, software, firmware, or any combination thereof including, for example, hardware and/or software combinational logic, sequential logic, timers, counters, registers, state machines, volatile memories such DRAM and/or SRAM, NVM including flash memory, persistent memory such as cross-gridded NVM, memory with bulk resistance change, PCM, and/or the like and/or any combination thereof, complex programmable logic devices (CPLDs), field programmable gate arrays (FPGAs), application specific circuits (ASICs), CPUs including CISC processors such as x86 processors and/or RISC processors such as ARM processors, graphics processing units (GPUs), neural processing units (NPUs), tensor processing units (TPUs), and/or the like, executing instructions stored in any type of memory. In some embodiments, one or more components may be implemented as a system-on-chip (SOC).

In embodiments implemented at least partially with a storage device having a flash translation layer (FTL) any of the functionality described herein (e.g., any of the storage device controllers, logic, and/or the like) may be implemented at least partially with an FTL.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a storage device, the method comprising:
monitoring a workload for a host's utilization of a memory device included in the storage device;
analyzing the monitored workload by detecting patterns of use of the memory device;
generating a recommendation to improve the host utilization, based on the analyzed, monitored workload; and
writing the recommendation to a log page in the storage device.

2. The method of claim 1, further comprising receiving, from the host, a first signal to activate the monitoring of the host's utilization of the memory device.

3. The method of claim 1, wherein the host's utilization of the memory device includes information related to at least one of input/output (I/O), a queue, a command parameter, or a queue depth.

4. The method of claim 1, wherein analyzing the monitored workload comprises recording a pattern, based on the monitored workload, that results in decreased utilization of the memory device.

5. The method of claim 4, wherein providing the recommendation to the host comprises:
determining a utilization change to address the pattern; and
generating the recommendation based on the determined utilization change.

6. The method of claim 1, further comprising receiving, from the host, a second signal to deactivate the monitoring of the host's utilization of the memory device.

7. The method of claim 6, wherein the recommendation is provided to the host, in response to receiving the second signal.

8. The method of claim 1, further comprising providing the host with a notification that the recommendation has been written to the log page.

9. A storage device, comprising:
a memory device;
a monitoring unit configured to monitor a workload for a host's utilization of the memory device;
an analysis unit configured to analyze the monitored workload by detecting patterns of use of the memory device; and
a recommendation unit configured to generate a recommendation to improve the host utilization, based on the analyzed, monitored workload, and write the recommendation to a log page in the storage device.

10. The storage device of claim 9, wherein the monitoring unit is further configured to receive, from the host, a first signal to activate the monitoring of the host's utilization of the memory device.

11. The storage device of claim 9, wherein the host's utilization of the memory device includes information related to at least one of input/output (I/O), a queue, a command parameter, or a queue depth.

12. The storage device of claim 9, wherein the analysis unit is further configured to record a pattern, based on the monitored workload, that results in decreased utilization of the memory device.

13. The storage device of claim 12, wherein the recommendation unit is further configured to:
determine a utilization change to address the pattern, and
generate the recommendation based on the determined utilization change.

14. The storage device of claim 9, wherein the monitoring unit is further configured to receive, from the host, a second signal to deactivate the monitoring of the host's utilization of the memory device.

15. The storage device of claim 14, wherein the recommendation is provided to the host, in response to receiving the second signal.

16. The storage device of claim 9, wherein the recommendation unit is further configured to provide the host with a notification that the recommendation has been written to the log page.

17. A nonvolatile memory express (NVMe) solid-state drive (SSD), the NVMe SSD comprising:
a memory device; and
a controller configured to:
monitor a workload for a host's utilization of the memory device,
analyzing the monitored workload by detecting patterns of use of the memory device,
generating a recommendation to improve the host utilization, based on the analyzed, monitored workload, and
writing the recommendation to a log page in the NVMe SSD.

18. The NVMe SSD of claim 17, wherein the controller is further configured to receive, from the host, a first signal to activate the monitoring of the host's utilization of the memory device.

19. The NVMe SSD of claim 17, wherein the host's utilization of the memory device includes information related to at least one of input/output (I/O), a queue, a command parameter, or a queue depth.

20. The NVMe SSD of claim 17, wherein the controller is further configured to record a pattern, based on the monitored workload, that results in decreased utilization of the memory device.
